(19) United States
(12) Patent Application Publication
(10) Pub. No.: US 2012/0026849 A1
(43) Pub. Date: Feb. 2, 2012

(54) OPTICAL DISC DEVICE

(75) Inventors: Toru SASAI, Osaka (JP); Jun Kikuchi, Osaka (JP); Hirotsugu Taniguchi, Osaka (JP)

(73) Assignee: PANASONIC CORPORATION, Osaka (JP)

(21) Appl. No.: 13/271,973

(22) Filed: Oct. 12, 2011

Related U.S. Application Data
(63) Continuation of application No. PCT/JP2010/002549, filed on Apr. 15, 2009.

(30) Foreign Application Priority Data
Apr. 15, 2009 (JP) 2009-099022

(51) Int. Cl. G11B 7/00

(52) U.S. Cl. 369/44.32; G9B/7

(57) ABSTRACT

An optical disc device includes: a focus error signal generation section configured to generate a focus error signal based on reflected light from an optical disc; and a focus control section configured to generate a drive signal for focus control of an optical pickup from the focus error signal. The focus control section includes a filter adjustment portion configured to activate a filter adjustment signal when the absolute value of the focus error signal is equal to or more than an error threshold, a proportional term computing unit, an integral term computing unit configured to multiply the focus error signal by an integral gain and integrate the multiplied result, a differential term computing unit, and an adder configured to add up results of these computing units to be output as the drive signal. The integral term computing unit decreases the integral gain when the filter adjustment signal is active.

### CROSS-REFERENCE TO RELATED APPLICATION

This is a continuation of PCT International Application PCT/JP2010/002549 filed on Apr. 7, 2010, which claims priority to Japanese Patent Application No. 2009-099022 filed on Apr. 15, 2009. The disclosures of these applications including the specifications, the drawings, and the claims are hereby incorporated by reference in their entirety.

### BACKGROUND

The present disclosure relates to an optical disc device, and more particularly to focus control performed by the optical disc device.

In recent years, recording media such as compact discs (CDs) and digital versatile discs (DVDs) are being used for car-mounted disc drives, video recorders, camcorders, etc. Optical disc devices using such recording media may fail to continue its focus control (focus servo) when having undergone an impact from outside. Therefore, techniques of improving the trackability of focus control and, even if defocus occurs, avoiding collision between an objective lens and an optical disc are in high demand.

In optical disc devices, a coil for focusing in an optical pickup is driven in accordance with a drive signal, to perform focus control in which the position of the optical pickup is controlled so that a light beam is focused on an information-recording layer of an optical disc. The drive signal is generated from a focus error signal obtained based on light reflected from the optical disc. The focus error signal indicates the distance between the focal point of the light beam and the information-recording layer of the optical disc. When defocus occurs due to an impact from outside, etc., the amount of light reflected from the optical disc decreases. When the reflected light amount falls, and continues to be, below a threshold, it is determined that defocus has been detected. Once this is determined, an avoidance pulse is output as the drive signal to increase the distance between the objective lens of the optical pickup and the optical disc, thereby controlling to avoid collision between the objective lens and the optical disc. An example of such an optical disc device is disclosed in Japanese Patent Publication No. H11-185259 and Japanese Patent Publication No. 2008-210489.

### SUMMARY

The focus error signal does not become completely zero even when focusing completely fails. Since the loop for focus control remains closed until defocus is detected, the drive signal gradually increases by a low-frequency compensation filter, whereby the objective lens becomes closer and closer to the optical disc. If the objective lens is excessively close to the optical disc, it may collide with the optical disc. To avoid this, the time taken until it is determined that defocus has been detected may just be shortened. However, this has a demerit that, since the frequency of detection of defocus increases, the focus servo tends to fail.

It is an objective of the present disclosure to provide an optical disc device capable of keeping an objective lens from colliding with an optical disc.

The optical disc device of an embodiment of the present disclosure includes: a focus error signal generation section configured to generate a focus error signal based on reflected light from an optical disc; and a focus control section configured to generate a drive signal for focus control of an optical pickup from the focus error signal. The focus control section includes a first filter adjustment portion configured to activate a first filter adjustment signal when the absolute value of the focus error signal is equal to or more than a first error threshold, a proportional term computing unit configured to multiply the focus error signal by a predetermined value, an integral term computing unit configured to multiply the focus error signal by an integral gain and integrate the multiplied result of the integral term computing unit, a differential term computing unit configured to differentiate the focus error signal, an adder configured to add up the computed results of the proportional term computing unit, the integral term computing unit, and the differential term computing unit and output the added result as the drive signal, and an acceleration measurement section configured to measure the acceleration of an objective lens of the optical pickup in a direction from the objective lens toward the optical disc. The integral term computing unit decreases the integral gain when the first filter adjustment signal is active. The first filter adjustment portion decreases the first error threshold when the acceleration measured by the acceleration measurement section is equal to or more than an acceleration threshold.

With the above configuration, in which the integral gain is decreased when the absolute value of the focus error signal is equal to or more than the first error threshold, an increase in the value of the integral term can be reduced. Therefore, the objective lens can be kept from getting too close to the optical disc, permitting avoidance of collision between the objective lens and the optical disc.

According to the embodiment of the present disclosure, since the increase in the value of the integral term is reduced at the time of defocus, the objective lens can be kept from getting too close to the optical disc. Thus, collision between the objective lens and the optical disc can be avoided.

### BRIEF DESCRIPTION OF THE DRAWINGS

FIG. 1 is a block diagram showing an example configuration of an optical disc device of an embodiment of the present disclosure.

FIG. 2 is a block diagram showing an example configuration of a focus control section in FIG. 1.

FIG. 3 is a block diagram showing an example configuration of a filter adjustment portion in FIG. 2.

FIG. 4 is a flowchart showing a flow of processing by the optical disc device of FIG. 1.

FIGS. 5A-5F are charts respectively illustrating the distance between an objective lens and an optical disc (5A), a focus error signal (5B), a reflected light amount (5C), a drive signal (5D), a detection signal (5E), and a first filter adjustment signal (5F).

FIG. 6 is a block diagram showing a variation of the focus control section in FIG. 1.

FIG. 7 is a block diagram showing an example configuration of a filter adjustment portion in FIG. 6.

FIG. 8 is a flowchart showing a flow of processing by the optical disc device having the focus control section of FIG. 6.

FIGS. 9A-9G are charts respectively illustrating the distance between an objective lens and an optical disc (9A), a focus error signal (9B), a reflected light amount (9C), a drive signal (9D), a detection signal (9E), a first filter adjustment signal (9F), and a second filter adjustment signal (9G).

FIG. 10 is a block diagram showing a variation of the filter adjustment portion of FIG. 3.

FIG. 11 is a block diagram showing a variation of the filter adjustment portion of FIG. 7.

FIG. 12 is a flowchart showing a flow of processing by the optical disc device having the filter adjustment portions of FIGS. 10 and 11.

FIG. 13 is a block diagram showing a configuration of a variation of the optical disc device of FIG. 1.

FIG. 14 is a block diagram showing an example configuration of a focus control section in FIG. 13.

FIG. 15 is a block diagram showing an example configuration of a filter adjustment portion in FIG. 14.

FIG. 16 is a block diagram showing an example configuration of another filter adjustment portion in FIG. 14.

FIG. 17 is a flowchart showing a flow of processing related to setting of an error threshold by the optical disc device of FIG. 13.

### DETAILED DESCRIPTION

An embodiment of the present disclosure will be described hereinafter with reference to the accompanying drawings. Note that, throughout the drawings, components denoted by reference numerals same in the last two digits correspond with each other: they are the same or similar components.

The function blocks as defined herein can be implemented typically by hardware. For example, each of the function blocks can be formed on a semiconductor substrate as part of an integrated circuit (IC). As used herein, the IC includes a large-scale integrated circuit (LSI), an application-specific integrated circuit (ASIC), a gate array, a field programmable gate array (FPGA), etc. Alternatively, part or the entire of each of the function blocks can be implemented by software. For example, such a function block can be implemented by a program executed on a processor. In other words, the function blocks to be described herein may be implemented by hardware, by software, or by an arbitrary combination of hardware and software.

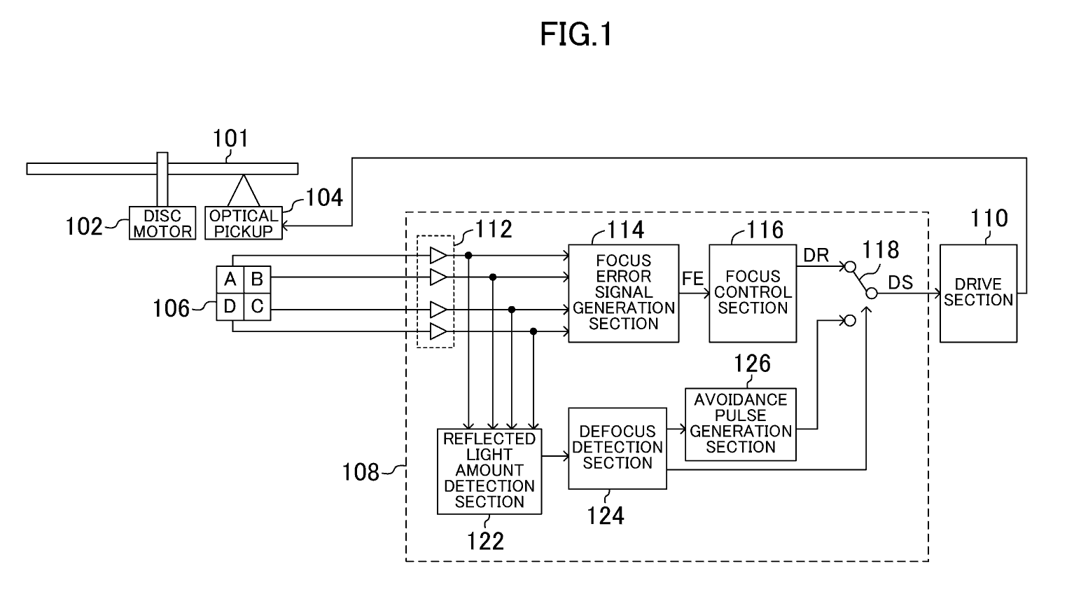

FIG. 1 is a block diagram showing an example configuration of an optical disc device of an embodiment of the present disclosure. The optical disc device of FIG. 1 includes a disc motor 102 that rotates an optical disc 101 mounted, an optical pickup 104, a detector 106, a drive signal generation block 108, and a drive section 110. The drive signal generation block 108 includes preamplifiers 112, a focus error signal generation section 114, a focus control section 116, a switch 118, a reflected light amount detection section 122, a defocus detection section 124, and an avoidance pulse generation section 126.

The optical pickup 104 in FIG. 1 directs focused laser light onto the optical disc 101. The detector 106 receives light reflected from the optical disc 101 via the optical pickup 104. The detector 106 has four light receiving elements, which individually generate electric signals corresponding to the received light amounts and output the signals to the preamplifiers 112. The preamplifiers 112 amplify the input signals and output the results to the focus error signal generation section 114 and the reflected light amount detection section 122.

The focus error signal generation section 114 generates a focus error signal FE indicating the distance between the focal point of the light beam and the information-recording surface of the optical disc 101 based on the signals amplified by the preamplifiers 112, and outputs the signal to the focus control section 116. The focus control section 116 performs automatic gain control (AGC), phase compensation, and low-frequency compensation for the focus error signal FE, and outputs the resultant drive signal DR to the switch 118.

The switch 118 normally selects the drive signal DR and outputs the signal to the drive section 110 as a drive signal DS for focus control of the optical pickup 104. The control section 110 outputs the drive signal DS after amplifying its current, to drive the coil for focusing in the optical pickup 104, thereby performing focus control in which the position of the optical pickup 104 is controlled so that the light beam is focused on the information-recording layer of the optical disc.

The reflected light amount detection section 122 generates a reflected light amount signal corresponding to the amount of the reflected light based on the signals amplified by the preamplifiers 112, and outputs the signal to the defocus detection section 124. The defocus detection section 124 detects defocus that may occur due to an impact from outside. In other words, the defocus detection section 124 compares the reflected light amount signal with a predetermined detection level, and, if the time period during which the reflected light amount signal is smaller than the predetermined detection level (defocus detection period) reaches a predetermined time length, determines that defocus has been detected. Once determining the detection of defocus, the defocus detection section 124 outputs a signal indicating the defocus to the avoidance pulse generation section 126 and the switch 118.

Having received the signal indicating the defocus, the avoidance pulse generation section 126 generates an avoidance pulse AP. The switch 118 selects the avoidance pulse AP and outputs the signal to the drive section 110 as the drive signal DS. The avoidance pulse AP is a square wave pulse having a voltage with which the objective lens in the optical pickup 104 is forced away from the optical disc 101.

Thus, having received the signal indicating the defocus, the avoidance pulse generation section 126 outputs the avoidance pulse AP to the drive section 110. With this signal, the objective lens moves in the direction away from the optical disc 101. In this way, the objective lens can be avoided from colliding with the optical disc 101.

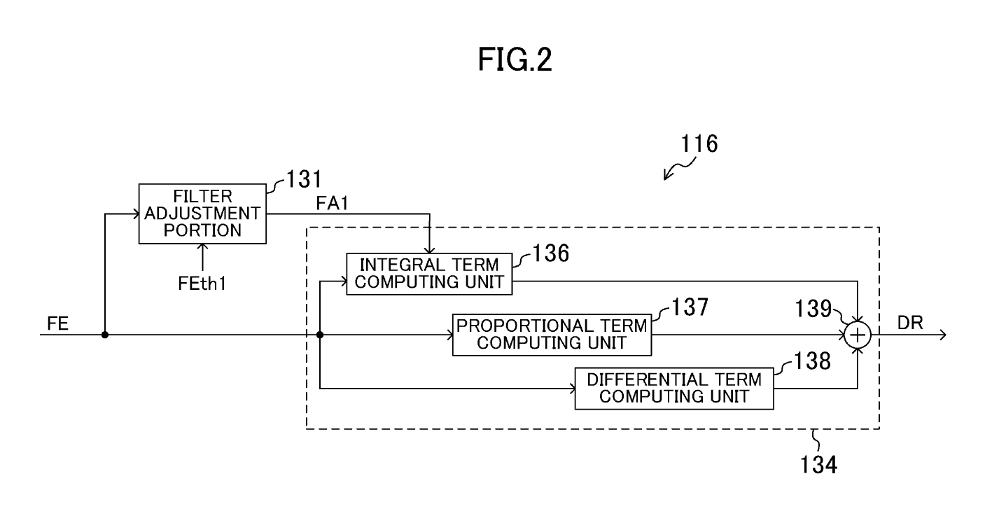

FIG. 2 is a block diagram showing an example configuration of the focus control section 116 in FIG. 1. The focus control section 116 includes a first filter adjustment portion 131 and a computation portion 134. The computation portion 134 includes an integral term computing unit 136, a proportional term computing unit 137, a differential term computing unit 138, and an adder 139.

The integral term computing unit 136 integrates the focus error signal FE, to increase the gain in the low-frequency region of the focus error signal FE. More specifically, the integral term computing unit 136 multiplies the focus error signal FE by an integral gain and adds up the multiplied results at predetermined intervals, to obtain the integrated result. The proportional term computing unit 137 multiplies the focus error signal by a predetermined value: i.e., the proportional term computing unit 137 determines the degree of amplification of the focus error signal FE. The differential term computing unit 138 differentiates the focus error signal FE to perform phase compensation of the focus error signal FE.

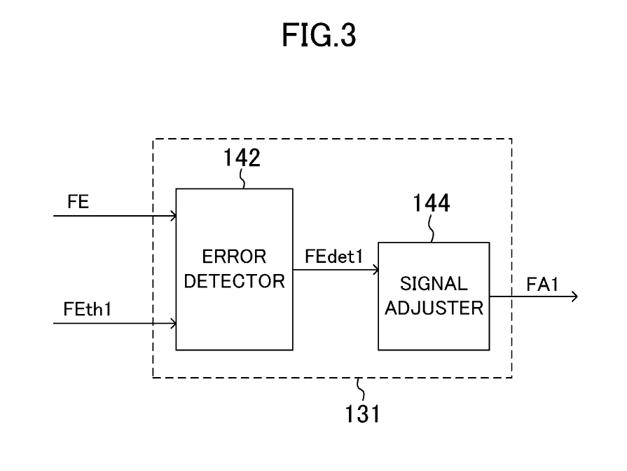

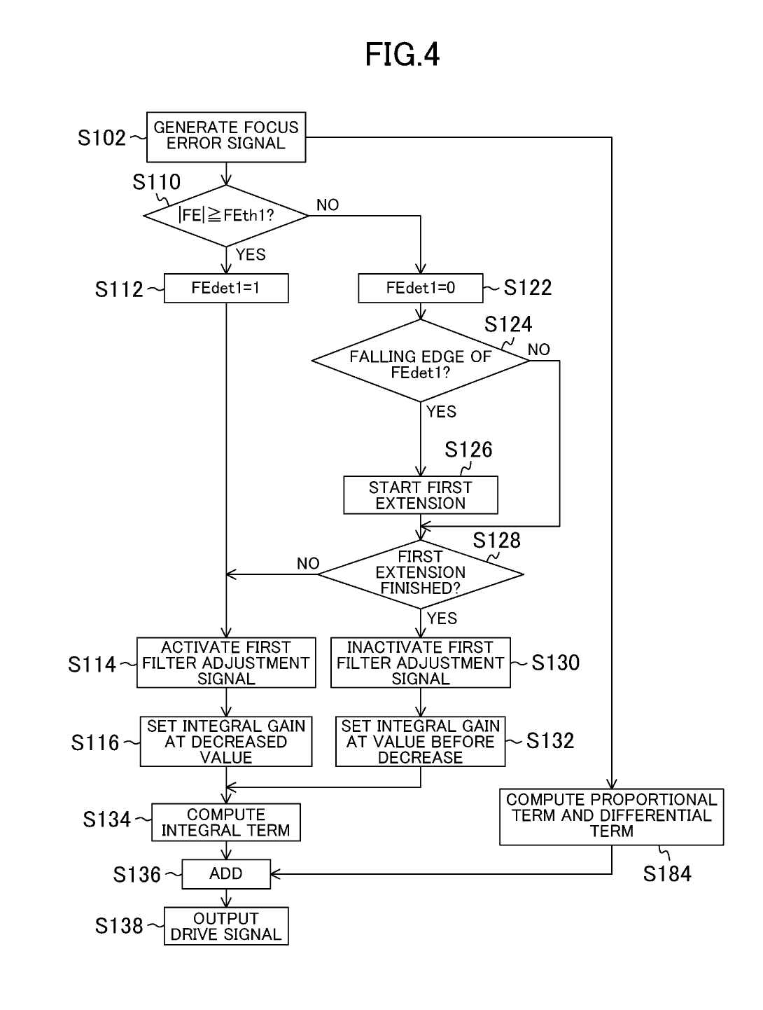

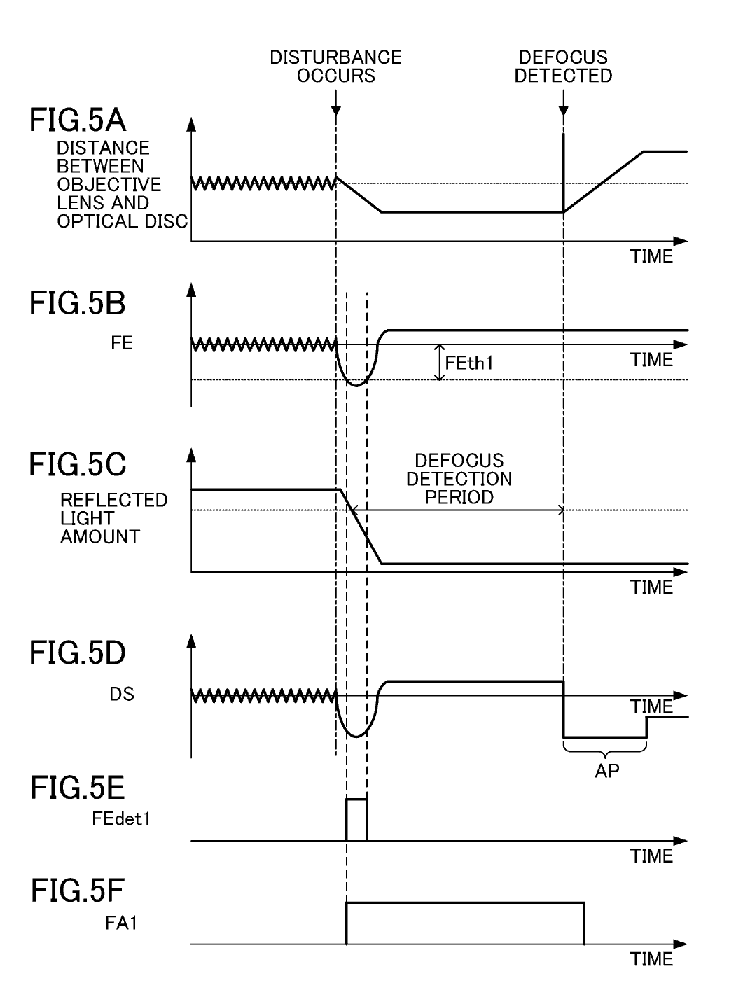

FIG. 3 is a block diagram showing an example configuration of the filter adjustment portion 131 in FIG. 2. The filter adjustment portion 131 includes an error detector 142 and a signal adjuster 144. FIG. 4 is a flowchart showing a flow of processing by the optical disc device of FIG. 1. FIGS. 5A-5F are charts respectively illustrating the distance between the objective lens and the optical disc (5A), the focus error signal FE (5B), the reflected light amount (5C), the drive signal DS (5D), a detection signal FEdet1 (5E), and a first filter adjustment signal FA1 (5F). The defocus detection period shown in FIG. 5C refers to, for example, the time period from the time at which the reflected light amount falls below a predetermined value through the time for which the reflected light amount remains below the predetermined value until the time at which the defocus detection section 124 determines that defocus has been detected. In FIG. 5D, the avoidance pulse AP generated by the avoidance pulse generation section 126 after the detection of defocus is shown.

The operation of the optical disc device of FIG. 1 will be described hereinafter with reference to FIGS. 1-5E. The focus error signal generation section 114 in FIG. 1 generates the focus error signal FE based on the signals amplified by the preamplifiers 112, and outputs the signal FE to the focus control section 116 (S102).

The error detector 142 in FIG. 3 determines whether or not the absolute value of the focus error signal FE is equal to or more than an error threshold FEth1 (S110). The processing proceeds to S112 if the error detector 142 determines that the absolute value of the focus error signal FE is equal to or more than the error threshold FEth1 (i.e., if an error is detected), or proceeds to S122 if the error detector 142 determines that the former is less than the latter. The error threshold FEth1 may be a value set previously by a controller (not shown) outside the focus control section 116 or may be a fixed value.

In S112, the error detector 142 sets the detection signal FEdet1 at “1” and outputs the signal. In S122, the error detector 142 sets the detection signal FEdet1 at “0” and outputs the signal. In S114, with the detection signal FEdet1=1, the signal adjuster 144 activates a first filter adjustment signal FA1 (sets the signal FA1 at “1”) and outputs the signal to the integral term computing unit 136. In S116, with the first filter adjustment signal FA1 being active, the integral term computing unit 136 decreases the integral gain from its initial value, for example, and sets the gain at the resultant decreased value.

In S124, the signal adjuster 144 detects a falling edge of the detection signal FEdet1. The processing proceeds to S126 if a falling edge has been detected, or proceeds to S128 if no falling edge has been detected. The signal adjuster 144 has a down counter. In S126, the down counter is set at a fixed value, to start a first extension for the defocus detection period. Assume herein that the value set for the down counter is a fixed value larger than the value corresponding to the defocus detection period, for example. The down counter counts down in accordance with a clock.

In S128, the signal adjuster 144 determines whether the first extension has finished or not, i.e., whether the value of the down counter is zero or not. The processing proceeds to S114 if the value of the down counter is not zero. At this time, the down counter decrements the value. The processing proceeds to S130 if the value of the down counter is zero.

In S130, the signal adjuster 144 inactivates the first filter adjustment signal FA1 and outputs the signal to the integral term computing unit 136. In S132, with the first filter adjustment signal FA1 being inactive, the integral term computing unit 136 sets the integral gain at the previous value before the decrease in S116 (e.g., the initial value).

In S134, the integral term computing unit 136 integrates the focus error signal FE using the set integral gain and outputs the integrated result to the adder 139. In S184, the proportional term computing unit 137 multiplies the focus error signal FE by a predetermined value and outputs the multiplied result to the adder 139. Also, the differential term computing unit 138 differentiates the focus error signal FE and outputs the differentiated result to the adder 139. In 5136, the adder 139 adds up the computed results of the integral term computing unit 136, the proportional term computing unit 137, and the differential term computing unit 138. In S138, the adder 139 outputs the added result as the drive signal DR.

When the first filter adjustment signal FA1 is activated as shown in FIG. 5F, the integral gain of the integral term computing unit 136 decreases. This reduces increase in the drive signal DS of FIG. 5D, and thus reduces decrease in the distance between the objective lens and the optical disc of FIG. 5A. In other words, the objective lens can be kept from getting too close to the optical disc. Thus, collision between the objective lens and the optical disc during the defocus detection period can be avoided.

The drive signal generation block 108 may be formed on a single semiconductor substrate, or only part of the drive signal generation block 108 including the focus control section 116 may be formed on a single semiconductor substrate. Otherwise, part of the focus control section 116 may be formed on another semiconductor substrate.

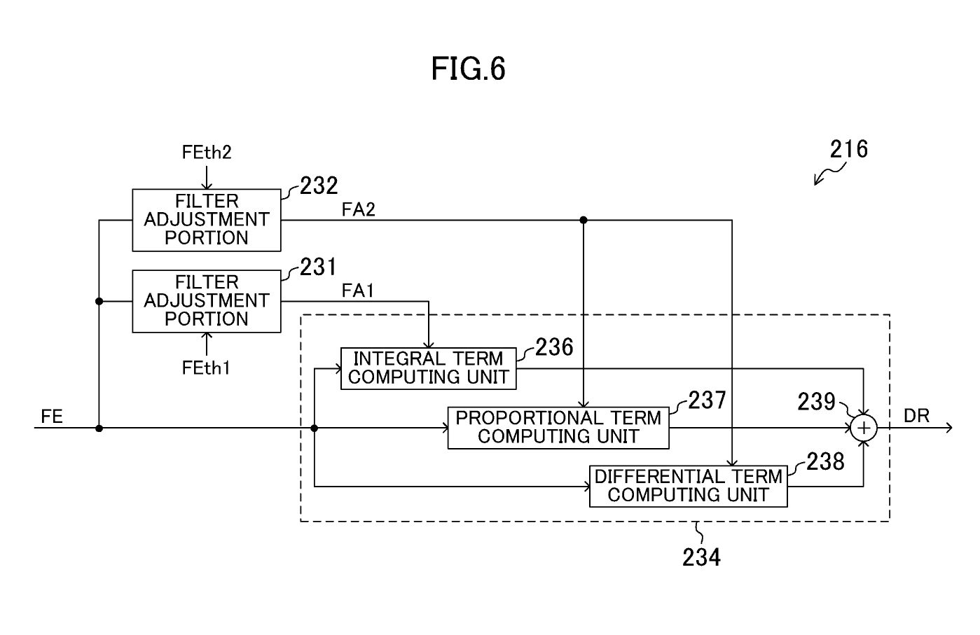

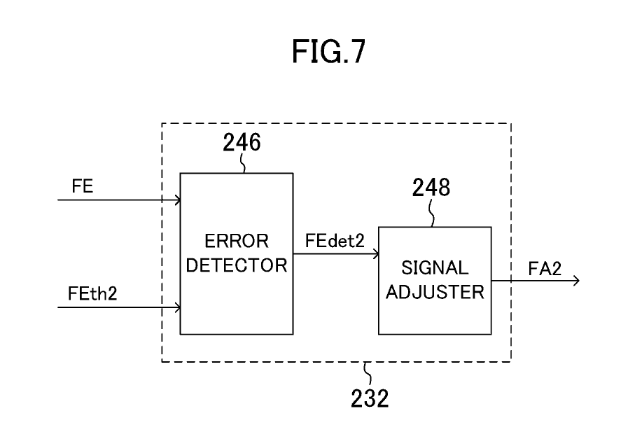

FIG. 6 is a block diagram showing a variation of the focus control section 116 in FIG. 1. A focus control section 216 of FIG. 6 is different from the focus control section 116 in FIG. 1 in that a second filter adjustment portion 232 is additionally provided, and is used in the optical disc device of FIG. 1 in place of the focus control section 116. FIG. 7 is a block diagram showing an example configuration of the filter adjustment portion 232 in FIG. 6. The filter adjustment portion 232 includes an error detector 246 and a signal adjuster 248.

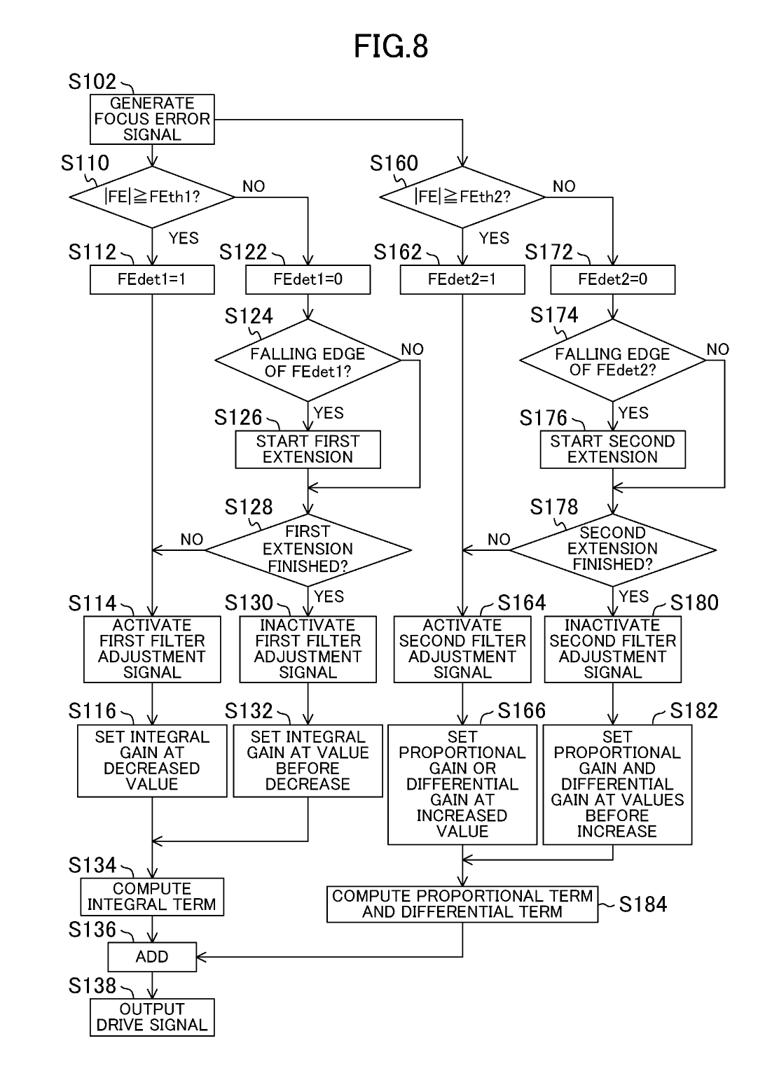

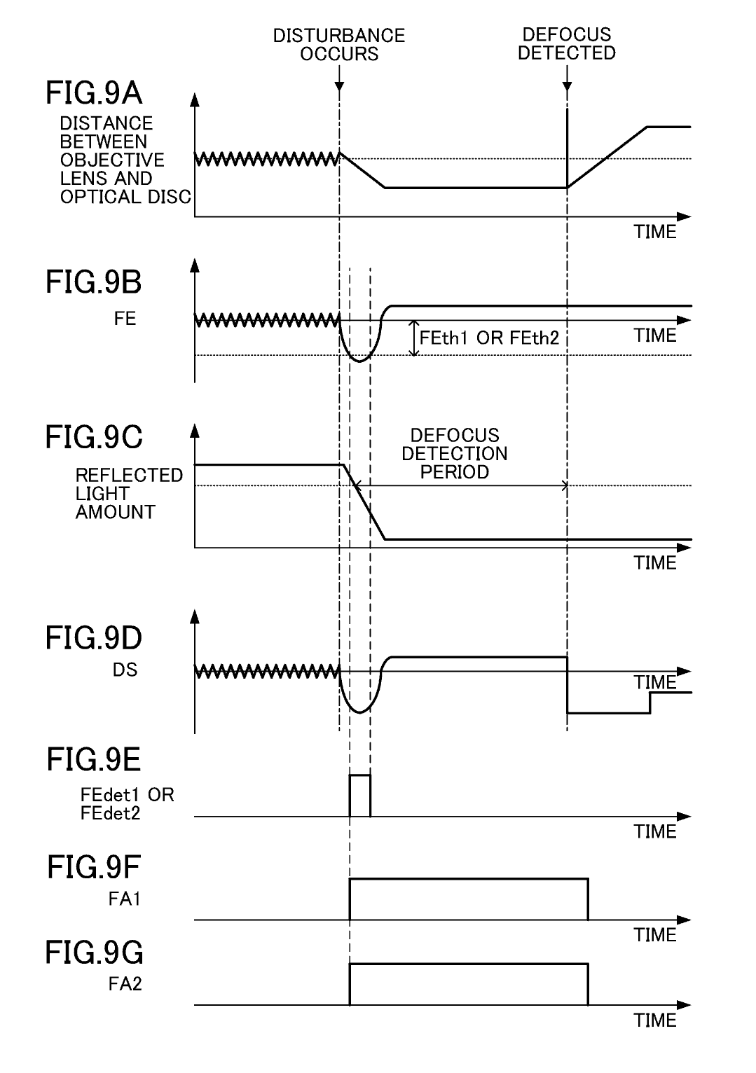

FIG. 8 is a flowchart showing a flow of processing by the optical disc device having the focus control section 216 of FIG. 6. FIGS. 9A-9G are charts respectively illustrating the distance between the objective lens and the optical disc (9A), the focus error signal FE (9B), the reflected light amount (9C), the drive signal DS (9D), the detection signal FEdet1 or FEdet2 (9E), the first filter adjustment signal (9F), and a second filter adjustment signal (9G).

The operation of the optical disc device having the focus control section 216 of FIG. 6 will be described hereinafter with reference to FIGS. 6-9G. The steps S102 through S134 are similar to those in FIG. 4. Description of these steps is therefore omitted here.

The error detector 246 in FIG. 7 determines whether or not the absolute value of the focus error signal FE is equal to or more than an error threshold FEth2 (S160). The processing proceeds to S162 if the error detector 246 determines that the absolute value of the focus error signal FE is equal to or more than the error threshold FEth2, or proceeds to S172 if the error detector 246 determines that the former is less than the latter. The error threshold FEth2 may be a value set previously by a controller outside the focus control section 216 or may be a fixed value.

In S162, the error detector 246 sets the detection signal FEdet2 at “1” and outputs the signal. In S172, the error detector 246 sets the detection signal FEdet2 at “0” and outputs the signal. In S164, with the detection signal FEdet2=1, the signal adjuster 248 activates the second filter adjustment signal FA2 and outputs the signal to the proportional term computing unit 237 and the differential term computing unit 238. In S166, with the second filter adjustment signal FA2 being active, the proportional term computing unit 237 and the differential term computing unit 238 set at least one of the proportional gain or the differential gain at a value increased from its initial value, for example.

In S174, the signal adjuster 248 detects a falling edge of the detection signal FEdet2. The processing proceeds to S176 if a falling edge has been detected, or proceeds to S176 if no falling edge has been detected. The signal adjuster 248 has a down counter. In S176, the down counter is set at a fixed value, to start a second extension for the defocus detection period. Assume herein that the value set for the down counter is a fixed value larger than the value corresponding to the defocus detection period, for example. The down counter counts down in accordance with a clock.

In S178, the signal adjuster 248 determines whether the second extension has finished or not, i.e., whether the value of the down counter is zero or not. The processing proceeds to S164 if the value of the down counter is not zero. At this time, the down counter decrements the value. The processing proceeds to S180 if the value of the down counter is zero.

In S180, the signal adjuster 248 inactivates the second filter adjustment signal FA2 and outputs the signal to the proportional term computing unit 237 and the differential term computing unit 238. In S182, with the second filter adjustment signal FA2 being inactive, the proportional term computing unit 237 and the differential term computing unit 238 set the proportional gain and the differential gain at the previous values before the increase in S166 (e.g., the initial values).

In S184, the proportional term computing unit 237 multiplies the focus error signal FE by a predetermined value, further multiplies the multiplied result by the proportional gain, and outputs the result to the adder 239. The differential term computing unit 238 differentiates the focus error signal FE, multiplies the differentiated result by the differential gain, and outputs the result to the adder 239. In S136, the adder 239 adds up the computed results of the integral term computing unit 236, the proportional term computing unit 237, and the differential term computing unit 238. In S138, the adder 239 outputs the added result as the drive signal DR.

When the first filter adjustment signal FA1 goes active to decrease the integral gain, the trackability of steady-state fluctuations of the focus control system degrades, but instead the stability margin increases. This makes it possible to increase at least one of the proportional gain or the differential gain. Since more importance is placed on the trackability of steep fluctuations than on the trackability of steady-state fluctuations right after occurrence of a disturbance, it is useful, for stability of the focus control system, to decrease the integral gain and increase at least one of the proportional gain or the differential gain.

In the focus control section 216 of FIG. 6, when the second filter adjustment signal FA2 goes active as in FIG. 9G, at least one of the proportional gain of the proportional term computing unit 237 or the differential gain of the differential term computing unit 238 is set at an increased value. Therefore, right after occurrence of a disturbance, the trackability of steep fluctuations of the focus control system can be improved.

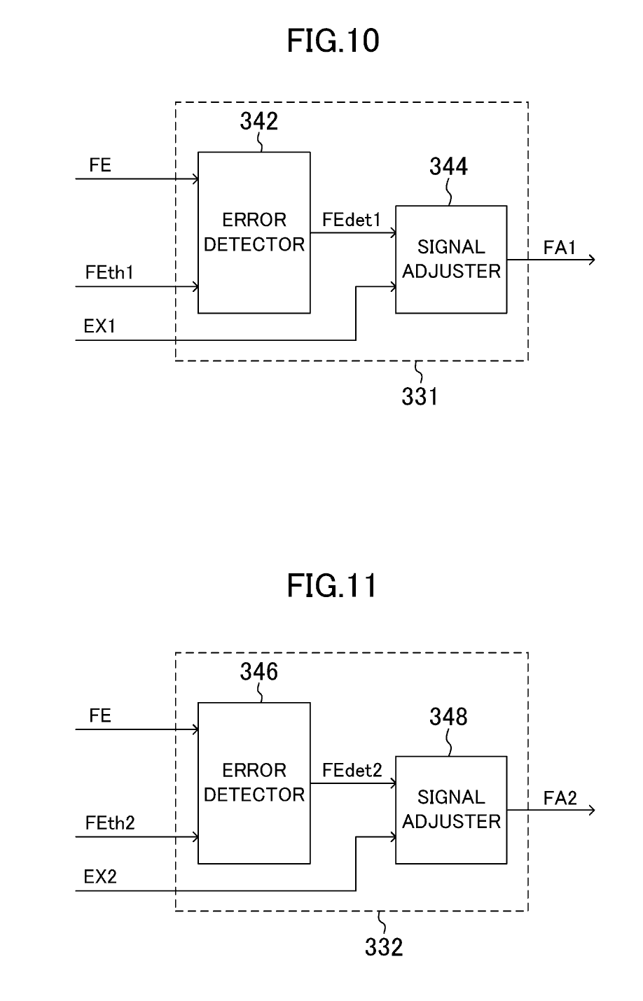

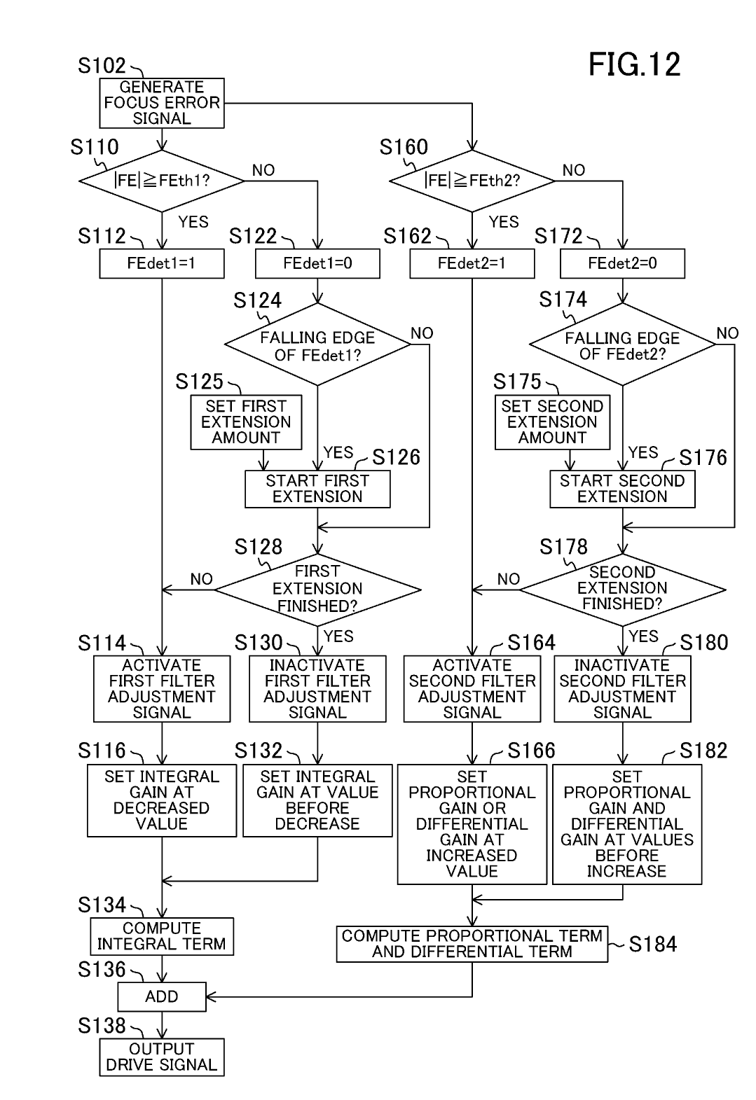

FIG. 10 is a block diagram showing a configuration of a variation of the filter adjustment portion 131 of FIG. 3. A filter adjustment portion 331 of FIG. 10 is different from the filter adjustment portion 131 of FIG. 3 in having a signal adjuster 344 in place of the signal adjuster 144. FIG. 11 is a block diagram showing a configuration of a variation of the filter adjustment portion 232 of FIG. 7. A filter adjustment portion 332 of FIG. 11 is different from the filter adjustment portion 232 of FIG. 7 in having a signal adjuster 348 in place of the signal adjuster 248. The filter adjustment portions 331 and 332 are used in the focus control section of FIG. 6 in place of the filter adjustment portions 231 and 232, respectively. FIG. 12 is a flowchart showing a flow of processing by an optical disc device having the filter adjustment portions 331 and 332 of FIGS. 10 and 11.

The signal adjusters 344 and 348 have their down counters. In S125 in FIG. 12, the value to be set for the down counter of the signal adjuster 344 (an extension amount EX1) is given to the signal adjuster 344 from a controller outside the focus control section 216, for example. In S175, similarly, the value to be set in the down counter of the signal adjuster 348 (an extension amount EX2) is given to the signal adjuster 348 from an external controller, for example. The extension amounts EX1 and EX2 can be changed with the system states such as the type of the optical disc, the readout rate from the optical disc, and the rotation control scheme, for example. Note that the extension amount EX1 should be a value at least larger than the defocus detection period, but the extension amount EX2 does not need to be a value larger than the defocus detection period.

In S126, with the setting of the extension amount EX1 for the down counter of the signal adjuster 344, the first extension for the defocus detection period is started. In S176, with the setting of the extension amount EX2 for the down counter of the signal adjuster 348, the second extension or the defocus detection period is started. The other steps of the processing in FIG. 12 are similar to those described above with reference to FIGS. 4 and 8.

The defocus detection period may be changed with the system states such as the type of the optical disc, the readout rate from the optical disc, and the rotation control scheme and the use environments of the optical disc device (e.g., car-mounted, etc.). In this case, also, the extension time of the first filter adjustment signal can be changed in association with the change of the defocus detection period.

The extension time of the second filter adjustment signal can also be changed with the system states and the use environments of the optical disc device described above. Therefore, the trackability can be improved only for steep fluctuations of the focus control system right after occurrence of a disturbance, and thus the focus control system can be stabilized during the defocus detection period.

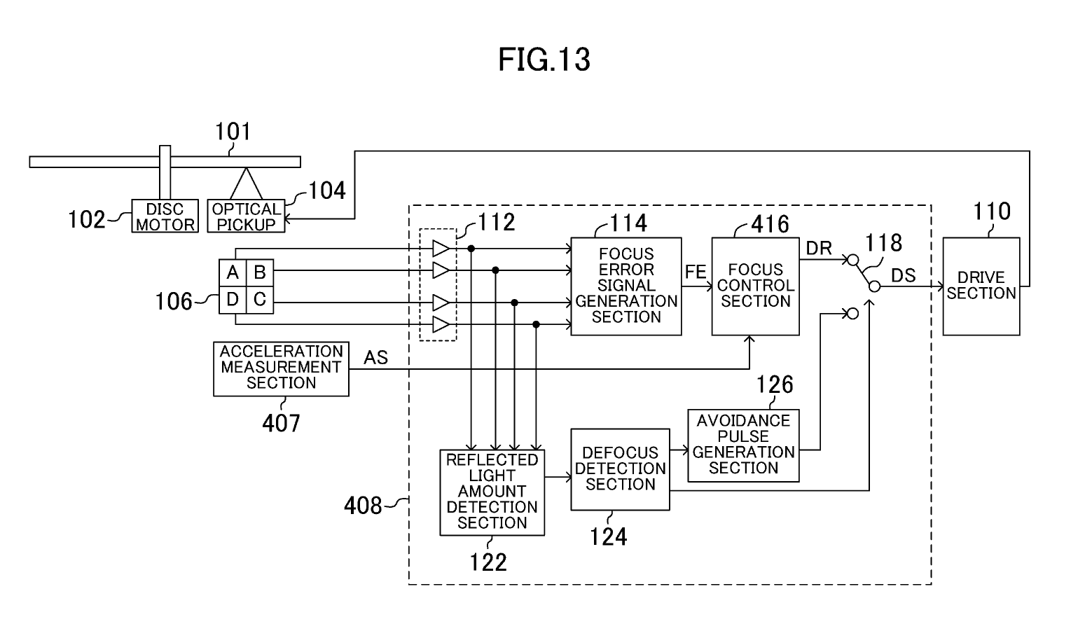

FIG. 13 is a block diagram showing a configuration of a variation of the optical disc device of FIG. 1. An optical disc device of FIG. 13 is different from the optical disc device of FIG. 1 in further having an acceleration measurement section 407 and having a drive signal generation block 408 in place of the drive signal generation block 108. The drive signal generation block 408 is different from the drive signal generation block 108 in FIG. 1 in having a focus control section 416 in place of the focus control section 116.

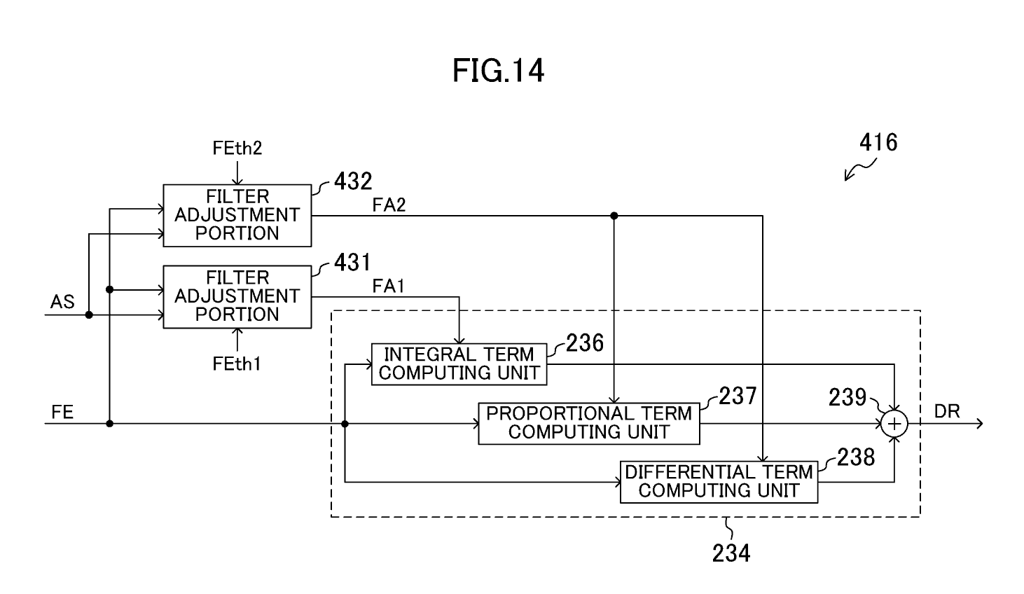

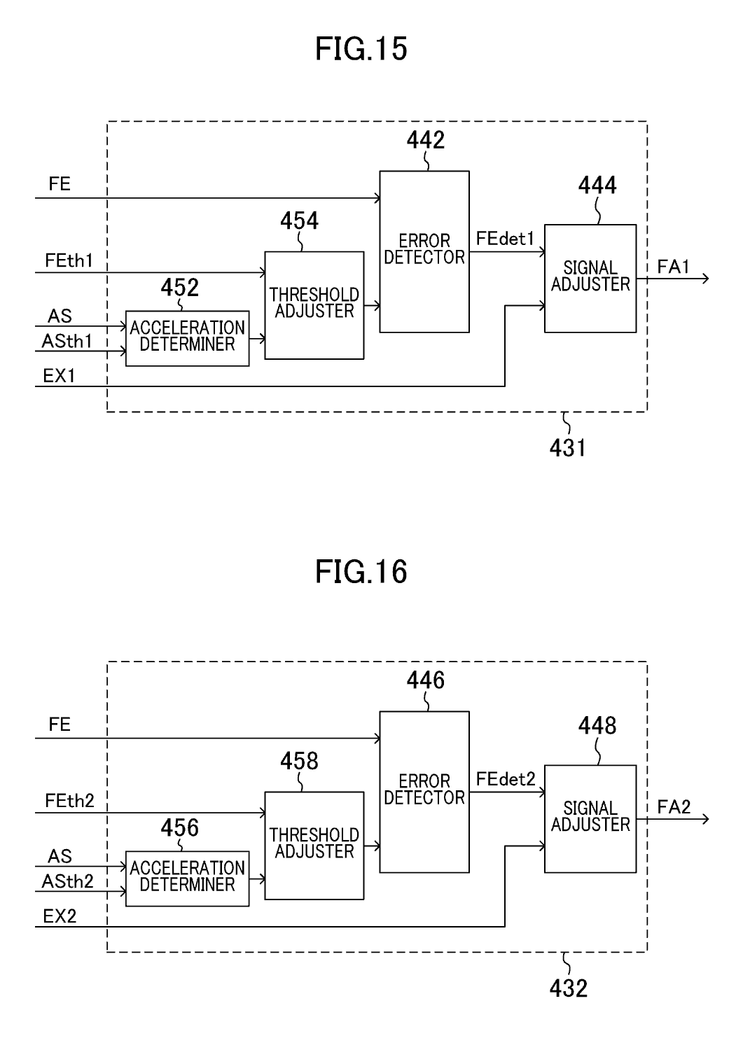

FIG. 14 is a block diagram showing an example configuration of the focus control section 416 in FIG. 13. The focus control section 416 is different from the focus control section 216 of FIG. 6 in having filter adjustment portions 431 and 432 in place of the filter adjustment portions 231 and 232. FIG. 15 is a block diagram showing an example configuration of the filter adjustment portion 431 in FIG. 14. The filter adjustment portion 431 includes an error detector 442, a signal adjuster 444, an acceleration determiner 452, and a threshold adjuster 454. FIG. 16 is a block diagram showing an example configuration of the filter adjustment portion 432 in FIG. 14. The filter adjustment portion 432 includes an error detector 446, a signal adjuster 448, an acceleration determiner 456, and a threshold adjuster 458.

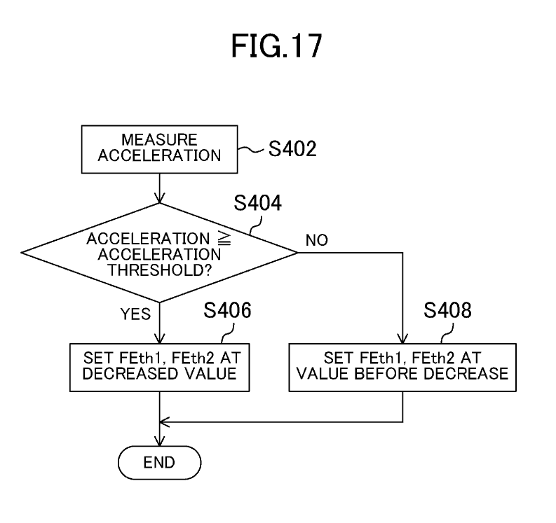

FIG. 17 is a flowchart showing a flow of processing on setting of the error thresholds FEth1 and FEth2 by the optical disc device of FIG. 13. Note that, in addition to the processing in FIG. 17, processing similar to that in FIG. 4, 8, or 12 is performed, for which the error thresholds FEth1 and FEth2 set in the processing in FIG. 17 are used. The operation of the optical disc device of FIG. 13 will be described with reference to FIGS. 13-17.

In S402, the acceleration measurement section 407 measures the acceleration of the objective lens of the optical pickup 104 with respect to the optical disc 101, and outputs the measured acceleration AS to the filter adjustment portions 431 and 432 of the focus control section 416. Assume herein that the direction from the objective lens toward the optical disc 101 is normal.

In S404-S408, the filter adjustment portion 431 performs the following processing: in S404, the acceleration determiner 452 determines whether or not the acceleration AS is equal to or more than an acceleration threshold ASth1, and outputs the determination result to the threshold adjuster 454. The processing proceeds to S406 if the acceleration AS is equal to or more than the acceleration threshold ASth1, or otherwise proceeds to S408. In S406, the threshold adjuster 454 decreases the input error threshold FEth1 and outputs the result to the error detector 442. In S408, the threshold adjuster 454 outputs the input error threshold FEth1 to the error detector 442 as it is.

In S404-S408, also, the filter adjustment portion 432 may perform the following processing: in S404, the acceleration determiner 456 determines whether or not the acceleration AS is equal to or more than an acceleration threshold ASth2, and outputs the determination result to the threshold adjuster 458. The processing proceeds to S406 if the acceleration AS is equal to or more than the acceleration threshold ASth2, or otherwise proceeds to S408. In S406, the threshold adjuster 458 decreases the input error threshold FEth2 and outputs the result to the error detector 446. In S408, the threshold adjuster 458 outputs the input error threshold FEth2 to the error detector 446 as it is. The acceleration thresholds ASth1 and ASth2 may be values set previously by a controller outside the focus control section 416 or may be fixed values.

When the error threshold FEth1 decreases, the error detector 442 is more likely to detect an error (FEdet1 is more likely to become 1). When the error threshold FEth2 decreases, the error detector 446 is more likely to detect an error (FEdet2 is more likely to become 1). Therefore, by allowing at least one of the filter adjustment portions 431 or 432 to perform the processing of S404-S408 to decrease at least one of the error thresholds FEth1 or FEth2, the stability of the focus control system can be maintained even if the acceleration in the direction from the objective lens toward the optical disc 101 is large.

As described above, in the embodiment of the present disclosure, collision between the objective lens and the optical disc can be avoided. Thus, the present disclosure is useful for optical disc devices, etc., in particular, optical disc devices used in portable apparatuses and car-mounted apparatuses susceptible to vibrations and impacts, for example.

Many features and advantages of the present disclosure are apparent from the written description, and thus, it is intended by the appended claims to cover all such features and advantages of the disclosure. Further, since numerous modifications and changes will readily occur to those skilled in the art, it is not desired to limit the disclosure to the exact construction and operation as illustrated and described. Hence, all suitable modifications and equivalents may be resorted to as falling within the scope of the invention.

What is claimed is:

1. An optical disc device, comprising:
a focus error signal generation section configured to generate a focus error signal based on reflected light from an optical disc;
a focus control section configured to generate a drive signal for focus control of an optical pickup from the focus error signal; and
an acceleration measurement section configured to measure the acceleration of an objective lens of the optical pickup in a direction from the objective lens toward the optical disc,
wherein
the focus control section includes
a first filter adjustment portion configured to activate a first filter adjustment signal when the absolute value of the focus error signal is equal to or more than a first error threshold,
a proportional term computing unit configured to multiply the focus error signal by a predetermined value,
an integral term computing unit configured to multiply the focus error signal by an integral gain and integrate the multiplied result of the integral term computing unit,
a differential term computing unit configured to differentiate the focus error signal, and
an adder configured to add up the computed results of the proportional term computing unit, the integral term computing unit, and the differential term computing unit and output the added result as the drive signal, and
wherein
the integral term computing unit decreases the integral gain when the first filter adjustment signal is active, and
the first filter adjustment portion decreases the first error threshold when the acceleration measured by the acceleration measurement section is equal to or more than an acceleration threshold.

2. The optical disc device of claim 1, wherein
the first filter adjustment portion changes the time period during which the first filter adjustment signal is active.

3. The optical disc device of claim 1,
wherein
the focus control section further includes
a second filter adjustment portion configured to activate a second filter adjustment signal when the absolute value of the focus error signal is equal to or more than a second error threshold, and
wherein
the proportional term computing unit and the differential term computing unit increase at least one of a proportional gain or a differential gain when the second filter adjustment signal is active,
the proportional term computing unit multiplies the multiplied result of the proportional term computing unit by the proportional gain, and
the differential term computing unit multiplies the differentiated result by the differential gain.

4. The optical disc device of claim 3, wherein
the second filter adjustment portion changes the time period during which the second filter adjustment signal is active.

5. An optical disc device, comprising:
a focus error signal generation section configured to generate a focus error signal based on reflected light from an optical disc;
a focus control section configured to generate a drive signal for focus control of an optical pickup from the focus error signal; and
an acceleration measurement section configured to measure the acceleration of an objective lens of the optical pickup in a direction from the objective lens toward the optical disc,
wherein
the focus control section includes
a first filter adjustment portion configured to activate a first filter adjustment signal when the absolute value of the focus error signal is equal to or more than a first error threshold,
a second filter adjustment portion configured to activate a second filter adjustment signal when the absolute value of the focus error signal is equal to or more than a second error threshold,
a proportional term computing unit configured to multiply the focus error signal by a predetermined value,
an integral term computing unit configured to multiply the focus error signal by an integral gain and integrate the multiplied result of the integral term computing unit,
a differential term computing unit configured to differentiate the focus error signal, and
an adder configured to add up the computed results of the proportional term computing unit, the integral term computing unit, and the differential term computing unit and output the added result as the drive signal, and
wherein
the integral term computing unit decreases the integral gain when the first filter adjustment signal is active,
the proportional term computing unit and the differential term computing unit increase at least one of a proportional gain or a differential gain when the second filter adjustment signal is active,
the proportional term computing unit multiplies the multiplied result of the proportional term computing unit by the proportional gain,
the differential term computing unit multiplies the differentiated result by the differential gain, and
the focus control section performs at least one of
first operation that the first filter adjustment portion decreases the first error threshold when the acceleration measured by the acceleration measurement section is equal to or more than a first acceleration threshold, or
second operation that the second filter adjustment portion decreases the second error threshold when the acceleration measured by the acceleration measurement section is equal to or more than a second acceleration threshold.
